(19) United States
(12) Patent Application Publication
(10) Pub. No.: US 2011/0075059 A1
(43) Pub. Date: Mar. 31, 2011

(54) LIQUID CRYSTAL DISPLAY TOUCH PANEL

(75) Inventors: PO-SHENG SHIH, Miao-Li County (TW); JIA-SHYONG CHENG, Miao-Li County (TW)

(73) Assignee: CHIMEI INNOLUX CORPORATION, Miao-Li County (TW)

(21) Appl. No.: 12/889,430

(22) Filed: Sep. 24, 2010

(30) Foreign Application Priority Data
Sep. 30, 2009 (CN) 200910308032.7

(51) Int. Cl. G02F 1/1335; G06F 3/041

(52) U.S. Cl. 349/12; 345/173

(57) ABSTRACT

An exemplary integrated LCD touch panel includes a first substrate, a second substrate, a liquid crystal layer and a driving control module. The first substrate includes scan lines, data lines, and contact sensor modules. Each sensor module comprises a sensor readout line, a readout transistor electrically connected to the sensor readout line and the scan line, and a contact electrode electrically connected to the readout transistor. The second substrate includes protrusions at a surface of the second substrate which faces toward the first substrate and positioned opposite to the contact electrode respectively. The liquid crystal layer is sandwiched between the first substrate and the second substrate. The driving control module is electrically connected to the readout lines and the data lines.

### BACKGROUND

1. Technical Field

The present disclosure relates to liquid crystal displays (LCDs), and more particularly, to an integrated LCD touch panel.

2. Description of the Related Art

Touch panels of an electronic device detect contact with a display surface and use the detected contact to implement desired operations of the electronic device. Analog resistive, capacitive, electromagnetic, surface acoustic wave, and infrared touch panels are all popularly used. Often, an LCD touch panel can be either a conventional LCD combined with an external touch panel, or an integrated LCD touch panel. Compared with the combined LCD touch panel, the integrated LCD touch panel provides a clearer image and higher display performance at low cost.

Referring to FIGS. 7 and 8, a typical integrated LCD touch panel 80 includes a TFT (Thin Film Transistor) substrate 81, and a color filter substrate 82 opposite thereto. The TFT substrate 81 includes a number of X sensor lines 811, a number of Y sensor lines 812, and a number of detection electrodes 813. The X sensor lines 811 are parallel to each other and evenly spaced on the TFT substrate 81. The Y sensor lines 812 are parallel to each other and evenly spaced on the TFT substrate 81. The X sensor lines 811 intersect with the Y sensor lines 812, and the X and Y sensor lines 811, 812 cooperatively define a number of sub-pixel areas. The detection electrodes 813 are arranged on the TFT substrate 81 adjoining the X sensor lines 811 and the Y sensor lines 812. The color filter substrate 82 includes a number of contact electrodes 821 (see FIG. 7) and a common electrode layer (not labeled) electrically connected to the contact electrodes 821. Contact by an external object with an outer surface of the color filter substrate 82 moves a contact electrode 821 corresponding to the contact position toward the TFT substrate 81 whereby the contact electrode 821 makes contact with one of the detection electrodes 813. A voltage between the detection electrode 813 and the X sensor line 811, and a voltage between the detection electrode 813 and the Y sensor line 812 are both changed. As a result, a driving control module (not shown) electrically connected to the X and Y sensor lines 811, 812 determines the touch position via the X and Y sensor lines 811, 812.

However, an aperture ratio of the integrated LCD touch panel is reduced due to the detection electrodes 813 sharing the sub-pixel areas. In addition, a cost of the integrated LCD touch panel is unduly high due to the employment of many X and Y sensor lines 811, 812. Furthermore, when the contact electrode 821 contacts the detection electrodes 813, the contact electrode 821 generates a short circuit with the X sensor line 811 and the Y sensor line 812. This causes voltage drift between the common electrode layer and a pixel electrode (not shown), which degrades the display quality.

Therefore, there is room for improvement within the art.

### SUMMARY

According to one aspect of the present disclosure, there is provided an integrated liquid crystal display (LCD) touch panel. An embodiment of the disclosure discloses an LCD touch panel includes a first substrate, a second substrate, a liquid crystal layer and a driving control module. The first substrate includes scan lines, data lines and contact sensor modules. Each contact sensor module includes a sensor readout line parallel to a corresponding data line, a readout transistor electrically connected to the sensor readout line and a corresponding scan line, and a contact electrode electrically connected to the readout transistor. The second substrate is parallel to the first substrate, and includes protrusions at a surface of the second substrate which faces toward the first substrate. The protrusions are positioned opposite to the contact electrodes, respectively. The liquid crystal layer is sandwiched between the first substrate and the second substrate. The driving control module is electrically connected to the sensor readout lines and the data lines. Each of the readout transistors is in a readout state when the readout transistor receives an input voltage from the adjacent scan line; and when the second substrate is elastically deformed one of the protrusions electrically contacts the corresponding contact electrode and the readout transistor receives a voltage signal from the contact electrode such that the readout transistor is activated and sends a sensing signal to the driving control module, which detects the position of the contacted readout transistor via the adjacent scan line and the corresponding sensor readout line.

An embodiment of the disclosure discloses an LCD touch panel includes a thin film transistor (TFT) substrate and a color filter (CF) substrate. The TFT substrate includes parallel scan lines, parallel data lines, sensor readout lines and contact sensor modules. The scan lines and the data lines cooperatively define a plurality of sub-pixel areas. The sensor readout lines are adjacent and parallel to the data lines, respectively. The contact sensor modules are disposed in the sub-pixel areas, respectively. Each contact sensor module includes a readout transistor electrically connected to a corresponding adjacent sensor readout line and a corresponding adjacent scan line, and a contact electrode electrically connected to the readout transistor. The CF substrate is parallel to the TFT substrate, and includes protrusions, a liquid crystal layer and a driving control module. The protrusions are located at an inner surface of the CF substrate, and positioned opposite to the contact electrodes, respectively. The liquid crystal layer is sandwiched between the TFT substrate and the CF substrate. The driving control module is electrically connected to the sensor readout lines and the data lines. Each of the readout transistors is in a readout state when the readout transistor receives an input voltage from the adjacent scan line; and when an outside of the second substrate is pressed inward one of the protrusions electrically contacts the corresponding contact electrode and the readout transistor receives a voltage signal from the contact electrode such that the readout transistor is activated and sends a sensing signal to the driving control module, which detects the position of the contacted readout transistor via the adjacent scan line and the corresponding sensor readout line.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is essentially a plan view of a sub-pixel region of a first embodiment of a liquid crystal display with an internal touch panel.

FIG. 2 is a cross-section of part of the liquid crystal display of FIG. 1, corresponding to line II-II thereof.

FIG. 3 is similar to FIG. 2, but shows the sub-pixel region when the internal touch panel is pressed.

FIG. 4 is essentially a plan view of a sub-pixel region of a second embodiment of a liquid crystal display with an internal touch panel.

FIG. 5 is a cross-section of part of the liquid crystal display of FIG. 4, corresponding to line V-V thereof.

FIG. 6 is similar to FIG. 5, but shows the sub-pixel region when the internal touch panel is pressed.

FIG. 7 is a cross-section of a pixel region of a typical liquid crystal display with an internal touch panel, the liquid crystal display also including a TFT substrate and a color filter substrate.

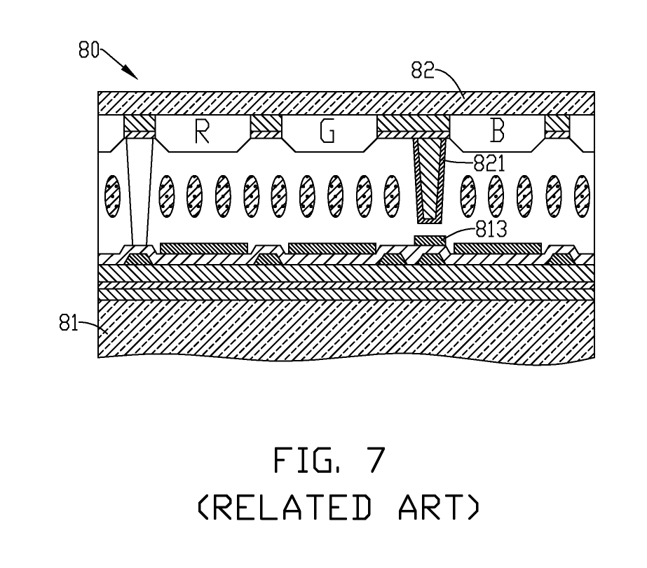

FIG. 8 is a plan view of the TFT substrate of FIG. 7.

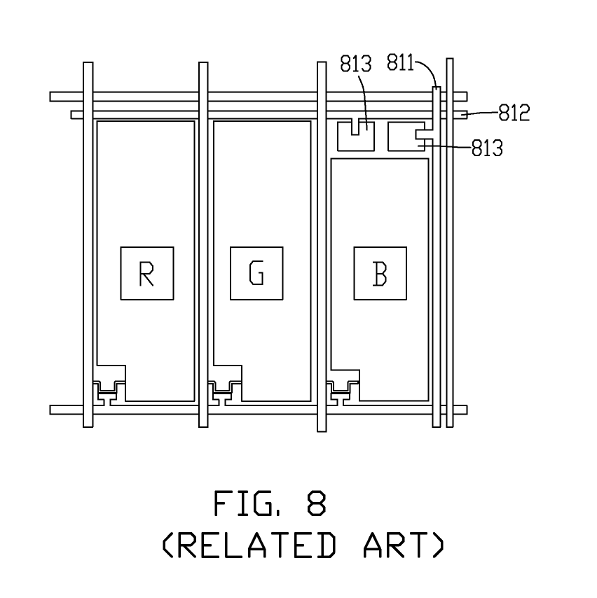

### DETAILED DESCRIPTION

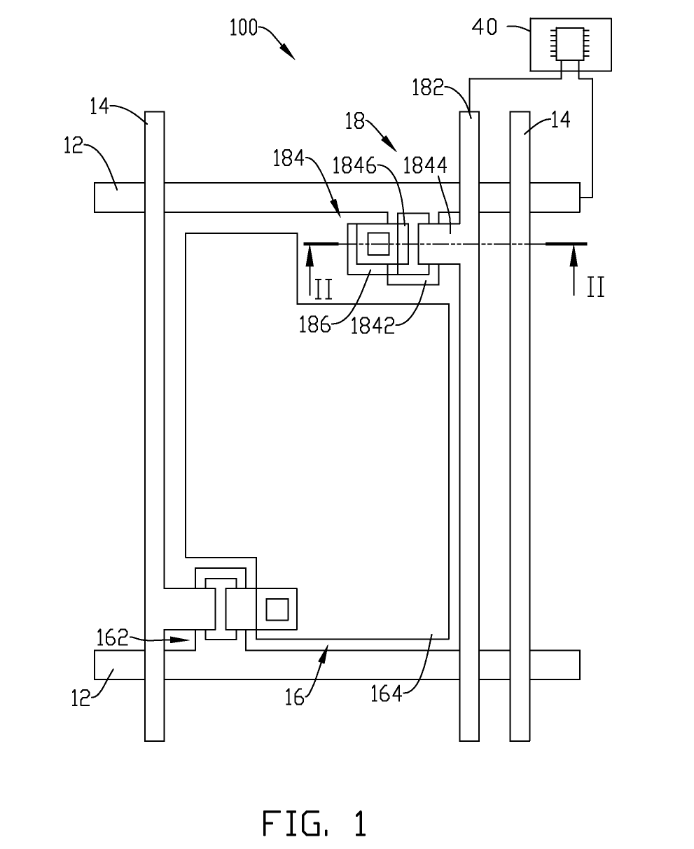

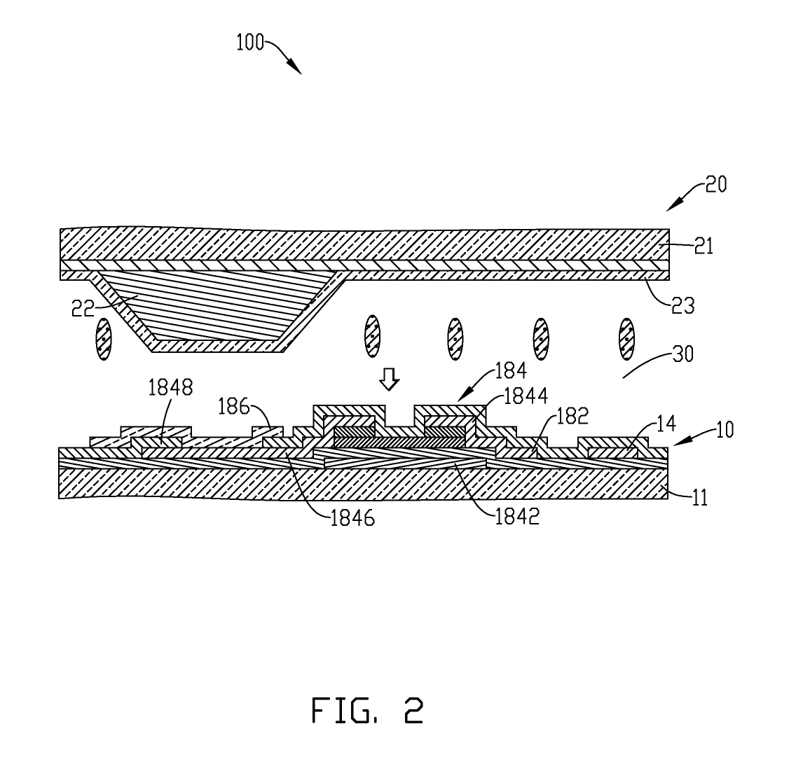

Referring to FIGS. 1 and 2, a first embodiment of an integrated LCD touch panel 100 includes a first substrate 10, a second substrate 20, a liquid crystal layer 30 and a driving control module 40. The first substrate 10 is parallel to the second substrate 20. The liquid crystal layer 30 is sandwiched between the first substrate 10 and the second substrate 20. The driving control module 40 is configured to detect contact that occurs with an external surface of the second substrate 20. Such contact is typically a user's fingertip or stylus touching the external surface of the second substrate 20.

The first substrate 10 includes a main body 11, a number of scan lines 12, a number of data lines 14, a number of sub-pixel driving control modules 16, and a number of contact sensor modules 18. The scan lines 12 are arranged at a surface of the main body 11 facing the second substrate 20, and are parallel to each other and evenly spaced from each other. The data lines 14 are parallel to each other and evenly spaced from each other, and intersect with the scan lines 12. The scan lines 12 and the data lines 14 cooperatively define a number of sub-pixel areas (not labeled). The sub-pixel driving control modules 16 and the contact sensor modules 18 are in each of the sub-pixel areas.

Each sub-pixel driving control module 16 includes a display control transistor 162 and a sub-pixel electrode 164. The display control transistor 162 is respectively electrically connected to the adjacent scan line 12, the adjacent data line 14, and the sub-pixel electrode 164. Each sub-pixel driving control module 16 further includes a driving control chip (not shown) electrically connected to the scan lines 12 and the data lines 14. The driving control chip controls an on-off status of the display control transistor 162 and a voltage of the sub-pixel electrode 164.

Each contact sensor module 18 is located in the vicinity of a corresponding intersection of the scan lines 12 and the data lines 14. Each contact sensor module 18 includes a sensor readout line 182, a readout transistor 184, and a contact electrode 186. The sensor readout line 182 is parallel to the data line 14. The readout transistor 184 is electrically connected to the adjacent sensor readout line 182, the adjacent data line 14, and the contact electrode 186. The scan line 12 inputs a voltage to the readout transistor 184, such that the readout transistor 184 is in a readout state. When the readout transistor 184 is in a readout state, the contact electrode 186 sends a sensor voltage signal to the readout transistor 184, and the readout transistor 184 is activated and sends a sensing signal to the driving control module 40 via the sensor readout line 182. The driving control module 40 detects the position of the contacted readout transistor 184 via the adjacent scan line 12 and the adjacent sensor readout line 182.

In the illustrated embodiment, the readout transistor 184 is a MOSTFT (Metal-Oxide Semiconductor Field Effect Transistor). The readout transistor 184 includes a gate electrode 1842, a source electrode 1844 and a drain electrode 1846. The gate electrode 1842 is electrically connected to the scan line 12. The source electrode 1844 is electrically connected to the sensor readout line 182. The drain electrode 1846 is electrically connected to the contact electrode 186. In one embodiment, for instance, a protection layer 1848 covers the drain electrode 1846. The protection layer 1848 defines a through hole (not labeled) to partially receive the contact electrode 186, such that the contact electrode 186 electrically contacts the drain electrode 1846. The readout transistor 184 is formed by a fourth photo-etching process (PEP4) or a fifth photo-etching process (PEPS).

The second substrate 20 includes a main body 21, a number of protrusions 22, a common electrode 23, and a color filter layer (not labeled). The color filter layer is on an inner surface of the main body 21 which faces toward the first substrate 10. The color filter layer includes a number of red, green and blue filter units. The protrusions 22 are provided on a surface of an underside of the color filter layer, and are positioned opposite to the contact electrodes 186, respectively. The common electrode 23 is plated on the surface of the color filter layer and the protrusions 22, so that the surface of the color filter layer and the protrusions 22 conduct electricity. A voltage can thus be generated between the common electrode 23 and the sub-pixel electrode 164 of each sub-pixel area.

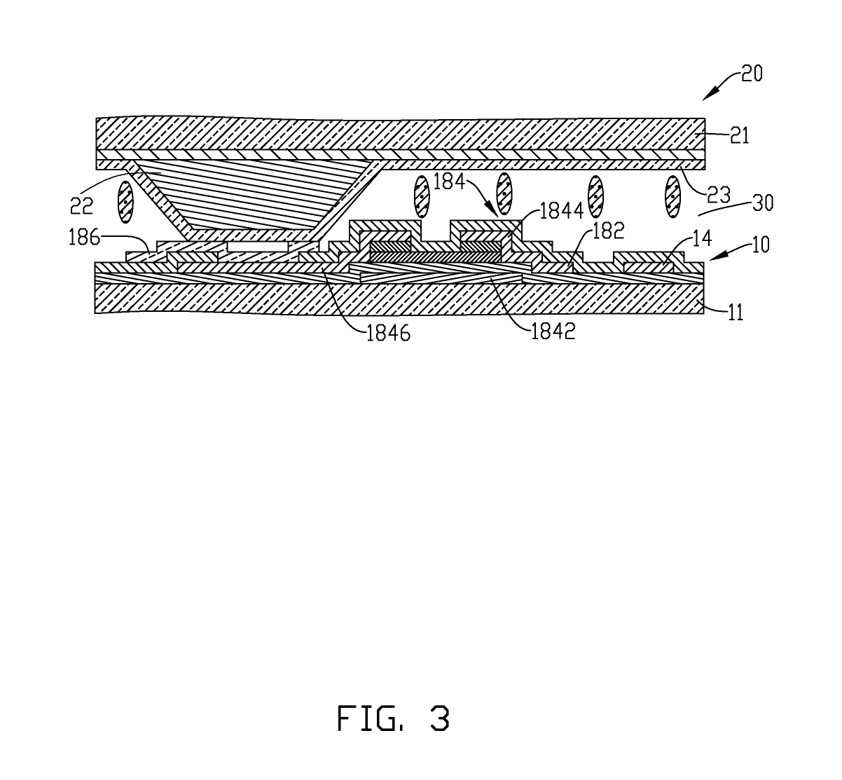

Referring also to FIG. 3, contact with an outer surface of the second substrate 20 elastically deforms the second substrate 20 and moves one or more of the protrusions 22 corresponding to the touch position toward the first substrate 10. In the following description, it is assumed that only one protrusion 22 moves. The protrusion 22 moves until the common electrode 23 contacts the contact electrode 186. A voltage signal is transmitted from the common electrode 23 to the readout transistor 184 via the contact electrode 186. The readout transistor 184 is activated, such that a current is transmitted from the drain electrode 184 to the sensor readout line 182 via the source electrode 1844. The driving control module 40 detects a position of the contacted readout transistor 184 via the sensor readout line 182 and the scan line 12, such that the driving control module 40 detects the contact position.

The gate electrode 1842 of the readout transistor 184 is electrically connected to the scan line 12, and the driving control module 40 receives a sensing signal from the scan line 12 by scanning. Thus the driving control module 40 can quickly detect the contact position. The contact sensor module 18 and the sub-pixel driving control module 16 share the same scan line 12, and do not need a number of X sensor lines. Thus an aperture ratio of the liquid crystal display with the internal touch panel 100 is increased. The readout transistor 184 can eliminate voltage drift between the common electrode 23 and the sub-pixel electrode 164, and thus optical viewing characteristics of the integrated LCD touch panel are improved.

It is to be understood that fewer contact sensor modules 18 than data lines 14 can be deployed, and fewer readout transistors 184 than display control transistors 162 can be deployed.

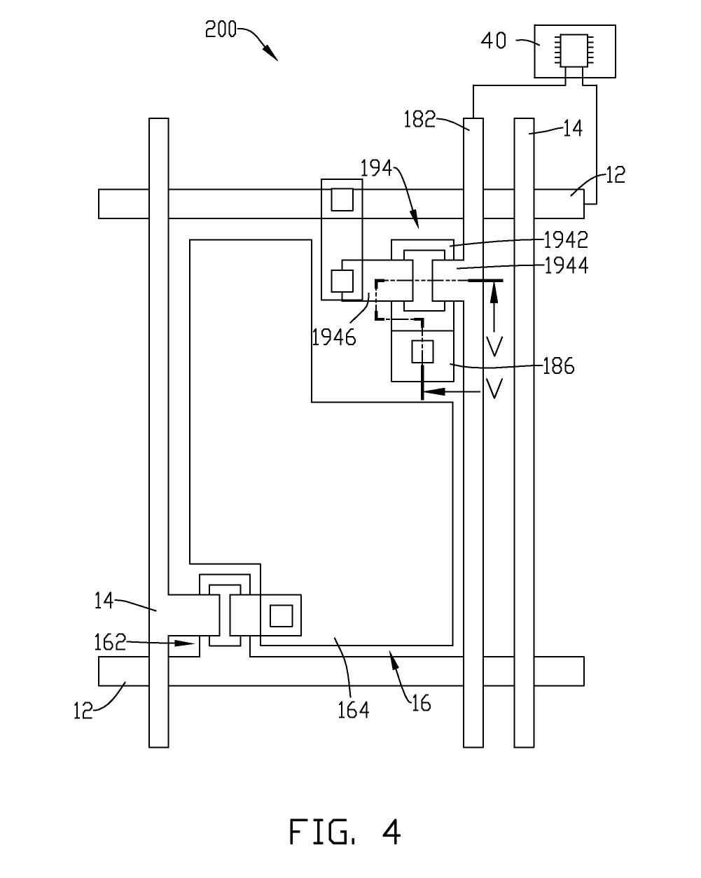

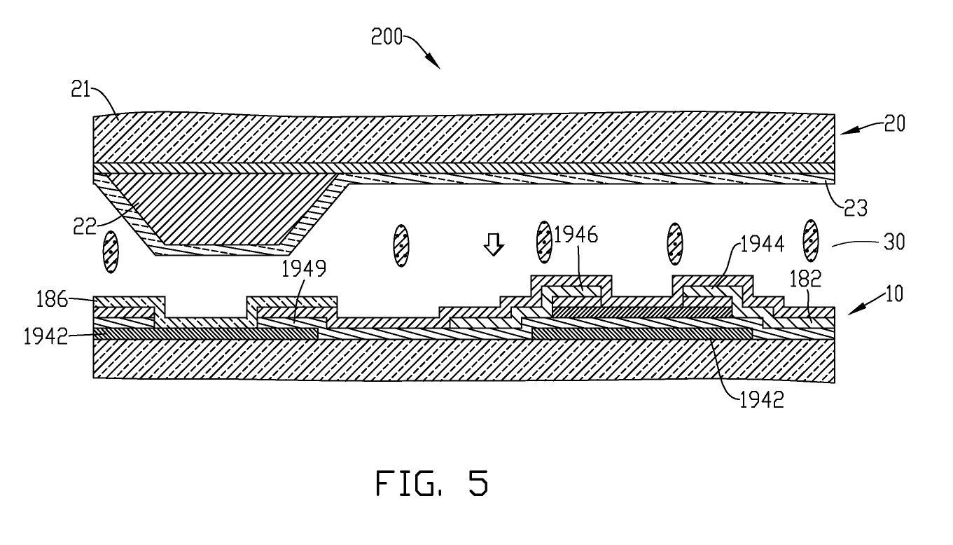

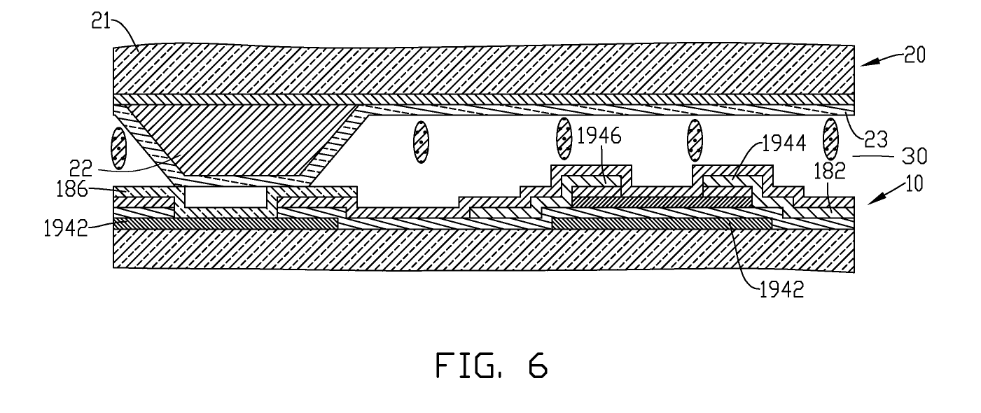

Referring to FIGS. 4 to 6, a second embodiment of an integrated LCD touch panel 200 differs from the first embodiment of the integrated LCD touch panel 100 only in that a readout transistor 194 includes a gate electrode 1942, a source electrode 1944, a drain electrode 1946 and an oxidation layer 1949. The gate electrode 1942 is electrically connected to the contact electrode 186. The source electrode 1944 is electrically connected to the sensor readout line 182. The drain electrode 1946 is electrically connected to the scan line 12. The oxidation layer 1949 covers the gate electrode 1942. The oxidation layer 1949 defines a through hole 1948 to partially receive the contact electrode 186, such that the contact electrode 186 electrically contacts the gate electrode 1942. When the common electrode 23 is put into electrically contact with the contact electrode 186, the readout transistor 194 is activated. Current is then transmitted from the drain electrode 1946 to the source electrode 1944, such that the driving control module 40 receives a voltage signal from the readout transistor 194 via the sensor readout line 182. The contact electrode 186 electrically contacts the gate electrode 1942, thus no voltage drift is generated between the common electrode 23 and the sub-pixel electrode 164.

Finally, while the present disclosure has been described with reference to particular embodiments, the description is illustrative and is not to be construed as limiting the disclosure. Therefore, various modifications can be made to the embodiments by those of ordinary skill in the art without departing from the true spirit and scope of the disclosure as defined by the appended claims.

What is claimed is:

1. An integrated liquid crystal display (LCD) touch panel, comprising:
a first substrate comprising:
a plurality of scan lines;
a plurality of data lines; and
a plurality of contact sensor modules, each comprising:
a sensor readout line parallel to a corresponding data line;
a readout transistor electrically connected to the sensor readout line and a corresponding scan line; and
a contact electrode electrically connected to the readout transistor;
a second substrate parallel to the first substrate, comprising:
a plurality of protrusions at a surface of the second substrate which faces toward the first substrate, the protrusions positioned opposite to the contact electrodes, respectively;
a liquid crystal layer sandwiched between the first substrate and the second substrate; and
a driving control module electrically connected to the sensor readout lines and the data lines, wherein each of the readout transistors is in a readout state when the readout transistor receives an input voltage from the adjacent scan line; and when the second substrate is elastically deformed one of the protrusions electrically contacts the corresponding contact electrode and the readout transistor receives a voltage signal from the contact electrode such that the readout transistor is activated and sends a sensing signal to the driving control module, which detects the position of the contacted readout transistor via the adjacent scan line and the corresponding sensor readout line.

2. The integrated LCD touch panel of claim 1, wherein the scan lines are arranged at a surface of the first substrate facing to the second substrate and are parallel to each other and evenly spaced from each other.

3. The integrated LCD touch panel of claim 2, wherein the data lines are parallel to each other and evenly spaced from each other, wherein the scan lines intersect with the data lines and cooperatively define a plurality of sub-pixel areas.

4. The integrated LCD touch panel of claim 3, wherein each contact sensor module is located in the vicinity of a corresponding intersection of the scan lines and the data lines.

5. The integrated LCD touch panel of claim 3, wherein the first substrate further comprises a plurality of sub-pixel driving control modules in the corresponding sub-pixel areas.

6. The integrated LCD touch panel of claim 5, wherein each sub-pixel driving control module comprises a display control transistor electrically connected to the corresponding scan line and the corresponding data line and a sub-pixel electrode electrically connect to the display control transistor.

7. The integrated LCD touch panel of claim 5, wherein each sub-pixel driving control module further comprises a driving control chip electrically connected to the scan line and the data line, wherein the driving control chip controls an on-off status of the display control transistor and a voltage of the sub-pixel electrode.

8. The integrated LCD touch panel of claim 1, wherein the readout transistor is a metal-oxide semiconductor field effect transistor.

9. The integrated LCD touch panel of claim 8, wherein the readout transistor comprises a gate electrode electrically connected to the corresponding scan line, a source electrode electrically connected to the sensor readout line and a drain electrode electrically connected to the contact electrode.

10. The integrated LCD touch panel of claim 9, wherein the readout transistor further comprises a protection layer covering the drain electrode and defining a through hole to partially receive the contact electrode.

11. The integrated LCD touch panel of claim 8, wherein the readout transistor comprises a gate electrode electrically connected to the contact electrode, a source electrode electrically connected to the sensor readout line, and a drain electrode electrically connected to the corresponding scan line.

12. The integrated LCD touch panel of claim 11, wherein the readout transistor further comprises an oxidation layer covering the gate electrode, wherein the oxidation layer defines a through hole to partially receive the contact electrode.

13. The integrated LCD touch panel of claim 1, wherein the second substrate further comprises a color filter layer on a surface of the second substrate thereof, on which the protrusions are formed.

14. The integrated LCD touch panel of claim 13, wherein the color filter layer consists of a plurality of red, green and blue filter units.

15. The integrated LCD touch panel of claim 13, wherein the second substrate further comprises a common electrode plated on a surface of the color filter layer and the protrusions.

16. An integrated liquid crystal display (LCD) touch panel, comprising:
a thin film transistor (TFT) substrate comprising:
a plurality of parallel scan lines;
a plurality of parallel data lines, the scan lines and the data lines cooperatively define a plurality of sub-pixel areas;
a plurality of sensor readout lines adjacent and parallel to the data lines, respectively; and
a plurality of contact sensor modules disposed in the sub-pixel areas, respectively, each contact sensor module comprising:
a readout transistor electrically connected to a corresponding adjacent sensor readout line and a corresponding adjacent scan line; and
a contact electrode electrically connected to the readout transistor;
a color filter (CF) substrate parallel to the TFT substrate, the CF substrate comprising:
a plurality of protrusions at an inner surface of the CF substrate, the protrusions positioned opposite to the contact electrodes, respectively;
a liquid crystal layer sandwiched between the TFT substrate and the CF substrate; and
a driving control module electrically connected to the sensor readout lines and the data lines, wherein each of the readout transistors is in a readout state when the readout transistor receives an input voltage from the adjacent scan line; and when an outside of the second substrate is pressed inward one of the protrusions electrically contacts the corresponding contact electrode and the readout transistor receives a voltage signal from the contact electrode such that the readout transistor is activated and sends a sensing signal to the driving control module, which detects the position of the contacted readout transistor via the adjacent scan line and the corresponding sensor readout line.

17. The integrated LCD touch panel of claim 16, wherein the readout transistor is a metal-oxide semiconductor field effect transistor.

18. The integrated LCD touch panel of claim 17, wherein the readout transistor comprises a gate electrode electrically connected to the corresponding scan line, a source electrode electrically connected to the sensor readout line and a drain electrode electrically connected to the contact electrode.

19. The integrated LCD touch panel of claim 18, wherein the readout transistor further comprises a protection layer covering the drain electrode and defining a through hole to partially receive the contact electrode.

20. The integrated LCD touch panel of claim 17, wherein the readout transistor comprises a gate electrode electrically connected to the contact electrode, a source electrode electrically connected to the sensor readout line, and a drain electrode electrically connected to the corresponding scan line.
